(19) United States
(12) Patent Application Publication
(10) Pub. No.: US 2013/0309054 A1
(43) Pub. Date: Nov. 21, 2013

(54) Wood Hauler

(71) Applicant: Raul Lazos, Phoenix, AZ (US)

(72) Inventor: Raul Lazos, Phoenix, AZ (US)

(21) Appl. No.: 13/866,761

(22) Filed: Apr. 19, 2013

Related U.S. Application Data
(60) Provisional application No. 61/687,153, filed on Apr. 19, 2012.

(51) Int. Cl. B66F 9/00

(52) U.S. Cl. CPC B66F 9/00
USPC 414/543

(57) ABSTRACT

The invention provides an assistive device specially designed to convey heavy logs of wood from the ground into a bed of a pickup truck. The Wood Hauler specifically is configured to mount into a tow hitch and provides multiple embodiments of lever arms, pulleys, winch and cable to attach, lift and maneuver logs into the bed of a pick up truck.

### CLAIM OF PRIORITY

This patent application claims priority under 35 USC 119 (e) (1) from U.S. Provisional Patent Application Ser. No. 61/687,153 filed Apr. 19, 2013, of common inventorship herewith entitled, “Wood Hauler.”

### FIELD OF THE INVENTION

The present invention pertains to the field of attachable trailers, and more specifically to the field of functional trailer equipment for trucks, and even more specifically to an attachable trailer for lifting logs of wood into the bed of a pickup truck.

### BACKGROUND OF THE INVENTION

The prior art has put forth several designs for functional truck trailers for lifting and hauling. Among these are:

U.S. Pat. No. 5,154,480 to Thomas J. Jones describes a pair of truck trailers, the first of which mounts on the fifth wheel of a pull truck and has a single axle at the rear end and the second of which has a front axle and a rear axle and connects to the rear of the first trailer. Each of the pair of trailers is convertible from a flatbed configuration for hauling units of finished lumber into a gondola configuration for hauling wood chips. Each trailer has a body consisting of a pair of upstanding, oppositely disposed sidewalls which are hinge mounted in a frame on the trailers and move from a vertical position forming the sides of a gondola body to a flatbed condition wherein the sidewalls pivot upwardly into an overlapped horizontal condition and form a flatbed body with a top over the flatbed.

U.S. Pat. No. 7,316,531 to Jerald M. Whitehead and Michael E. Banks describes a trailer having a trailer bed that may be a drop center type trailer and an extending frame structure including a forward frame, rearward frame and upper beam there between. Pivotable bunk assemblies having left and right portions are pivotably mounted to the trailer side rails, the bunk portions pivotable between a deployed position extending over the trailer and a non deployed position. A top frame is hingedly attached to the upper beam and engages the bunk assemblies when it is in the closed position. Deployable, load-bearing sidewalls are also optionally provided. The trailer is easily convertible between a configuration suitable for hauling logs in the deployed bunk assemblies and a configuration suitable for hauling other products such as wood chips with the bunk assemblies non deployed and the sidewalls deployed.

U.S. Pat. No. 7,794,188 to Jerald M. Whitehead and Todd Swanstrom describes methods and apparatus for pre bunking cut timber and transporting cut timber. A plurality of portable U shaped bunks or cradles are first releasably attached to a portable skid and logs are loaded onto the cradles. In an embodiment, the cradles are collapsible. This step may be performed before a transportation trailer is on site. The load of logs with portable cradles are then moved as a unit and attached to the trailer. The trailer is provided with attachment hardware adapted to releasably engage the portable bunks. In an embodiment of the invention, the trailer attachment hardware is removably attachable to the trailer, permitting the trailer to be used for other purposes. The present system permits improvements in efficiency by permitting logs to be pre bunked while the trailer is in use elsewhere.

None of these prior art references describe the present invention.

### SUMMARY OF THE INVENTION

It is an object of the present invention to provide an attachable trailer mechanism for lifting and placing timber logs in a truck bed.

### BRIEF DESCRIPTION OF THE DRAWINGS

FIG. 1 is a functional prototypical side view of a first embodiment showing a single cable, winch and cable with a log hooked and ready to be swiveled around into the truck bed. In this embodiment, the device is inserted in the truck's trailer hitch and stabilized by a section of metal frame extending diagonally to the ground.

FIG. 2 is a prototypical close up view of a second embodiment showing three pulleys positioned at appropriate leverage points, a resting stabilizing metal foot containing metal spikes for insertion into the ground, and a detachable one hundred degree swivel mechanism. This second embodiment also comprises spikes that are inserted into the ground for stabilization of the device.

FIG. 3 is a functional prototypical side view of a third embodiment showing a single pulley, winch, cable and hook for holding a log. This embodiment of the invention is inserted in a truck's trailer hitch and stabilized by a section of metal frame extending straight to the ground.

FIG. 4 is a functional prototypical side view of a fourth embodiment showing two pulleys, a winch, a cable and a hook for holding a log. The present invention is inserted in a truck's trailer hitch and stabilized by a section of metal frame extending diagonally to the ground.

### DETAILED DESCRIPTION OF THE INVENTION

Inventions are always a product of vision and creativity whether they are world changing inventions like cars and computers or everyday conveniences like pump hairsprays, cordless tools and re-sealable soda bottles. New inventions like a cell phone change a person's life style, making communication more convenient and accessible virtually anywhere. Other inventions such as a snow scraper and brush combine two already existing inventions into an improved embodiment, reducing clutter in our lives and making a daily winter chores much easier. Often necessity combined with a little creativity is the underlying motivator for an invention. Most inventions fill a relatively small need or perform a specialized limited function. If that need is shared by a sufficient number of consumers, an invention has a great potential for success.

The present invention, hereinafter referred to as the Wood Hauler, is an assistive device specially designed to convey heavy logs of wood from the ground into a bed of a pickup truck. The typically arduous process of lifting and placing heavy timber into a truck bed is completed without users incurring physical pain or serious injury. The present invention also is a useful device for workers who suffer from respiratory disease. The Wood Hauler specifically is configured to work in conjunction with a tow hitch provided on virtually any pickup truck model. Primarily comprised of two inch metal tubing, the durable Wood Hauler framework dimensions are approximately two to ten feet in length, two by seven feet in width and three inches to four feet in circumference. Other hardware comprising the present invention include pulleys, spikes, a winch, a cable wire and hook assembly, and a locking pin. An attachable swivel is provided to facilitate quick loading of wood into a truck bed.

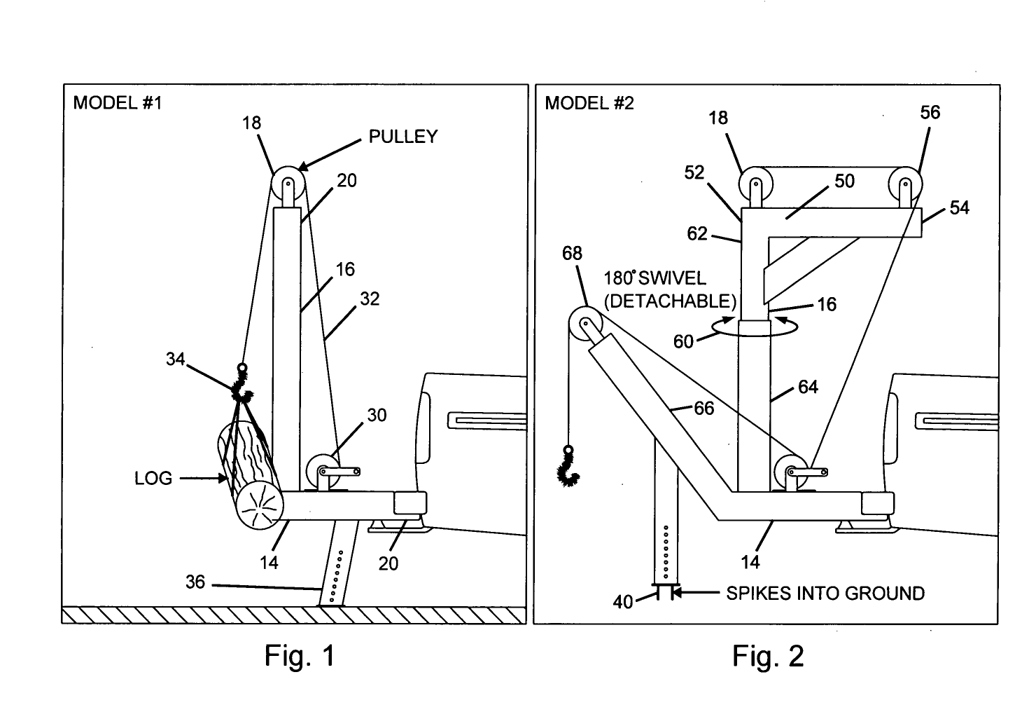

FIG. 1 shows an attachable trailer device for lifting and placing timber logs into a truck bed, comprising: a first section 14 of two inch metal tubing for insertion into the hitch 20 of a vehicle, and the tubing extends horizontally from the trailer hitch and wherein a second section 16 of two inch tubing extends vertically from the first section of tubing and wherein a pulley 18 is mounted on the top 20 of the second section of tubing and wherein a winch 30 is mounted on the first section of tubing 14 and a cable 32 extends from the winch 30 up through the pulley 18 and terminates in a hook 34 for attachment of a log, and a third section of tubing 36 extends from the bottom of the first section of tubing to the ground to stabilize the device when in use. The third section of tubing 36 extends at an angle from the bottom of the first section of tubing to the ground. The height of the second section 16 can be adjustable.

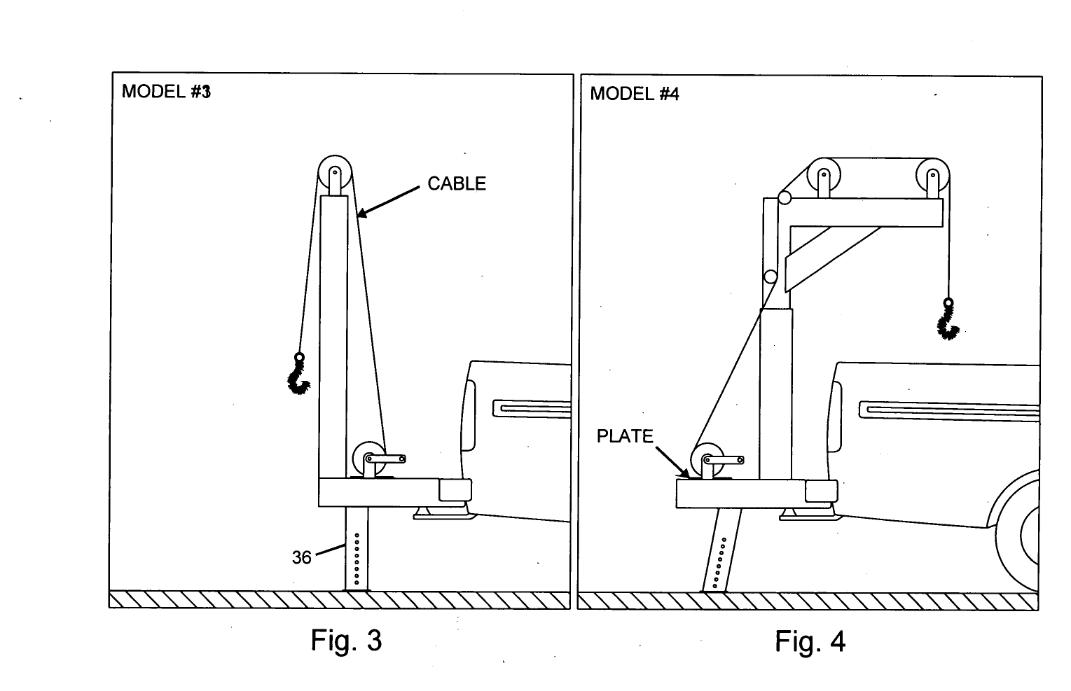

FIG. 3 shows the device of FIG. 1, with the exception that the third section of tubing 36 extends at a right angle from the bottom of the first section of tubing and is perpendicular to the first section of tubing. The height of the third section can be adjustable.

FIG. 2 shows the device having further features. This embodiment further Comprises spikes 40 at the bottom of the third section 36 of tubing for stabilization of the device by insertion of the spikes into the ground. Further, FIG. 2 shows an alternative embodiment further comprising a second horizontal section 50 perpendicular to the second section 16 and parallel to the first section 14, said second horizontal section 50 having a proximal 52 end and a distal end 54, wherein the proximal end 52 is attached to the second section 16 at a ninety degree angle, and wherein a second pulley 56 is mounted to the top of the second horizontal section 50 at the distal end 54 of the second horizontal section 50, additionally wherein the section comprises means 60 to rotate 180 degrees about a vertical axis. Additionally, the length of second horizontal section 50 can be adjustable. Any means of rotation is suitable, but one example is having second section 16 comprising an upper section 62 and a lower section 64 wherein the lower section 64 has a diameter slightly larger than the diameter of the upper section 62 so that the upper section 62 can rotate within the lower section 64. This embodiment further comprises an angular portion 66 extending from the distal end of the first section wherein said angular portion terminates in a third pulley 68.

FIG. 4 shows the device shown in FIG. 2 without angular portion extending from the distal end of the first section section.

The Wood Hauler is implemented by connecting the device to the truck's tow hitch and using a provided locking pin to secure the device steadfastly to the hitch. The winch then is connected to a trailer plug and manually lowered to the ground. The plug is designed for use with an electric winch. Lowering the cable wire and hook assembly, a user secures a hook and wire to a wooden log. The winch operated pulley system lifts a log off the ground, conveys the log over the pulley on to a swivel and delivers the log into the truck bed with a simple roll. This process is repeated until all the logs have filled the truck bed.

Designed with safety and convenience in mind, the Wood Hauler provides a simplified means of placing heavy logs of wood into waiting truck beds. Eliminating the need to bend and contort one's body to pick up logs and then manually lift them, the powered Wood Hauler prevents undue strain on one's back and leg muscles. The Wood Hauler circumvents debilitating injuries that may land one in the hospital or preclude them from being able to work. Configured with a practical assembly of winches and pulleys, the present invention is mastered easily by wood haulers of any stature whether burly bodybuilders or petite females. The Wood Hauler's simple mechanism permits a user to load truckloads of wood without requiring assistance from others. Fast loading, the Wood Hauler helps a user complete their wood hauling task in a fraction of the time normally required. While ideal for household consumers who heat their homes with wood burning fireplaces or stoves, the Wood Hauler also is highly effective and functional for professional loggers, making their jobs much easier and more productive. The Wood Hauler is an innovative invention which readily enhances log collection for all who engage in such a task. The Wood Hauler also is useful for farmers or ranchers who need to move heavy items such as water barrels, bags of stock feed, or hay bales. Installed in a matter of minutes, the Wood Hauler is an invaluable accessory for any pickup truck. Fabricated from durable, high quality materials and components, the Wood Hauler should withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An attachable trailer device for lifting and placing timber logs into a truck bed, comprising: a first section of two inch metal tubing for insertion into the hitch of a vehicle, and the tubing extends horizontally from the trailer hitch and wherein a second section of two inch tubing extends vertically from the first section of tubing and wherein a pulley is mounted on the top of the second section of tubing and wherein a winch is mounted on the first section of tubing and a cable extends from the winch up through the pulley and terminates in a hook for attachment of a log, and a third section of tubing extends from the bottom of the first section of tubing to the ground to stabilize the device when in use.

2. The device of claim 1 wherein the third section of tubing extends at an angle from the bottom of the first section of tubing.

3. The device of claim 1 wherein the third section of tubing extends at a right angle from the bottom of the first section of tubing and is perpendicular to the first section of tubing.

4. The device of claim 3 further comprising spikes at the bottom of the third section of tubing for stabilization of the device by insertion of the spikes into the ground.

5. The device of claim 4 further comprising a second horizontal section perpendicular to the second section and parallel to the first section, said second horizontal section having a proxiomal end and a distal end, wherein the proximal end is attached to the second section at a ninety degree angle, and wherein a second pulley is mounted to the top of the second horizontal section at the distal end of the second horizontal section, additionally wherein the section comprises means to rotate 180 degrees about a vertical axis.

6. The device of claim 5 further comprising an angular portion extending from the distal end of the first section wherein said angular portion terminates in a third pulley.

7. The device of claim 5, wherein the length of the second horizontal section is adjustable.
